(19) United States
(12) Patent Application Publication
(10) Pub. No.: US 2013/0302698 A1
(43) Pub. Date: Nov. 14, 2013

(54) NONAQUEOUS ELECTROLYTE BATTERY

(71) Applicants: Kazuhiro Goto, Itami-shi (JP); Takashi Uemura, Itami-shi (JP); Kentaro Yoshida, Itami-shi (JP); Tomoharu Takeyama, Itami-shi (JP); Ryoko Kanda, Itami-shi (JP)

(72) Inventors: Kazuhiro Goto, Itami-shi (JP); Takashi Uemura, Itami-shi (JP); Kentaro Yoshida, Itami-shi (JP); Tomoharu Takeyama, Itami-shi (JP); Ryoko Kanda, Itami-shi (JP)

(73) Assignee: SUMITOMO ELECTRIC INDUSTRIES, LTD., Osaka-shi, Osaka (JP)

(21) Appl. No.: 13/980,082

(22) PCT Filed: Jan. 18, 2012
(86) PCT No.: PCT/JP2012/050987

§ 371 Date: Jul. 17, 2013

(30) Foreign Application Priority Data
Jan. 19, 2011 (JP) 2011-009308

(51) Int. Cl. H01M 4/485; H01M 4/583

(52) U.S. Cl. CPC H01M 4/485; H01M 4/583
USPC 429/304; 429/209; 429/231.5; 429/231.8

(57) ABSTRACT

Provided is a nonaqueous electrolyte battery that has a high capacity and a high volume power density and can have an enhanced charge-discharge cycle capability. The nonaqueous electrolyte battery includes a positive-electrode layer, a negative-electrode layer, and a solid-electrolyte layer disposed between these layers. The negative-electrode layer contains a powder of a negative-electrode active material and a powder of a solid electrolyte. In the negative-electrode active material, a charge-discharge volume change ratio is 1% or less and the powder has an average particle size of 8 μm or less. The solid-electrolyte layer is formed by a vapor-phase process. Examples of the negative-electrode active material having a charge-discharge volume change ratio of 1% or less include Li₄Ti₅O₁₂ and non-graphitizable carbon.

### TECHNICAL FIELD

The present invention relates to a nonaqueous electrolyte battery including a positive-electrode layer, a negative-electrode layer, and a solid-electrolyte layer disposed between these layers.

### BACKGROUND ART

Nonaqueous electrolyte batteries have a long life, a high efficiency, and a high capacity and are used for portable devices such as cellular phones, notebook computers, and digital cameras. Representative examples of such nonaqueous electrolyte batteries include a lithium battery and a lithium-ion secondary battery (hereafter, simply referred to as “lithium-based batteries”), which utilize reactions of giving and receiving lithium ions between positive- and negative-electrode layers.

Such a lithium-based battery includes a positive-electrode layer containing a positive-electrode active material, a negative-electrode layer containing a negative-electrode active material, and an electrolyte layer disposed between these layers. The secondary battery is charged and discharged by transfer of lithium (Li) ions between the positive-electrode layer and the negative-electrode layer through the electrolyte layer. In addition, in recent years, all-solid-state batteries employing an inorganic solid electrolyte instead of an organic electrolytic solution have been proposed (for example, refer to Patent Literatures 1 to 3).

Regarding a technique of producing an all-solid-state battery, Patent Literature 1 states that a positive-electrode active-material powder, an electrolyte material powder, and a negative-electrode active-material powder are charged into a predetermined mold and pressed. On the other hand, Patent Literatures 2 and 3 state that a positive-electrode layer, a solid-electrolyte layer, and a negative-electrode layer are sequentially formed as films by a vapor-phase process so as to be stacked.

Patent Literature 3 also discloses use of a negative-electrode active material that is, for example, a carbon material such as graphite or hard carbon, silicon (Si), silicon oxide (SiOₓ (0<x<2)), a tin alloy, lithium-cobalt nitride (LiCoN), Li metal, or a lithium alloy (for example, LiAl) (paragraph 0050 of Patent Literature 3).

### CITATION LIST

### Patent Literature

PTL 1: Japanese Unexamined Patent Application Publication No. 2001-273928

PTL 2: Japanese Unexamined Patent Application Publication No. 2009-199920

PTL 3: Japanese Unexamined Patent Application Publication No. 2004-335455

### SUMMARY OF INVENTION

### Technical Problem

However, it is difficult to achieve an increase both in the capacity and in the volume power density (power density per unit volume) of existing all-solid-state nonaqueous electrolyte batteries (lithium-based batteries).

For example, in the case of the powder type as described in PTL 1 in which all the constituent members, that is, a positive-electrode layer, a solid-electrolyte layer, and a negative-electrode layer are formed by molding powders, the positive-electrode layer and the negative-electrode layer have a large thickness and the capacity is easily ensured; however, the solid-electrolyte layer also has a large thickness, resulting in a decrease in the volume power density. On the other hand, in the case of the film-formation type as described in PTLs 2 and 3 in which all the constituent members, that is, a positive-electrode layer, a solid-electrolyte layer, and a negative-electrode layer are formed as films by a vapor-phase process, the solid-electrolyte layer has a small thickness and the volume power density is easily ensured; however, the positive-electrode layer and the negative-electrode layer also have a small thickness, resulting in a decrease in the capacity.

The present invention has been made under the above-described circumstances. An object of the present invention is to provide a nonaqueous electrolyte battery that has a high capacity and a high volume power density and can have an enhanced charge-discharge cycle capability.

### Solution to Problem

The inventors of the present invention performed thorough studies and, as a result, have found the following findings.

The inventors of the present invention considered that an increase both in the capacity and in the volume power density of a battery can be achieved by molding a powder to form a negative-electrode layer and forming a solid-electrolyte layer as a film by a vapor-phase process. Thus, an all-solid-state nonaqueous electrolyte battery was actually produced by preparing a positive-electrode member in which a LiCoO₂-powder-molded body served as a positive-electrode layer and a solid-electrolyte layer was formed as a film by a vapor-phase process on the positive-electrode layer, and a negative-electrode member in which a graphite-powder-molded body served as a negative-electrode layer and a solid-electrolyte layer was formed as a film by a vapor-phase process on the negative-electrode layer; arranging these members so as to be in contact with each other such that the solid-electrolyte layers of the members faced each other and bonding these members together. This battery was subjected to a charge-discharge cycle test. As a result, in the battery, an internal short circuit occurred at the initial stage of the cycle test and the battery was found to have a problem in terms of charge-discharge cycle capability. This is probably because the negative-electrode layer expanded and contracted during charging and discharging and the resultant stress caused generation of cracks in the solid-electrolyte layer; Li deposited on the surface of the negative-electrode layer grew in a dendritic form so as to extend through the cracks during repeated charging and discharging; the Li dendrite reached the positive-electrode layer to cause the internal short circuit. In addition, the expansion and contraction of the negative-electrode layer during charging and discharging may cause degradation of the adhesion between the negative-electrode layer and the solid-electrolyte layer. In this case, Li-ion transfer resistance at the interface between the layers may increase, resulting in a decrease in the charge-discharge cycle capability.

The inventors of the present invention have found the above-described findings and have accomplished the present invention.

(1) A nonaqueous electrolyte battery according to the present invention includes a positive-electrode layer, a negative-electrode layer, and a solid-electrolyte layer disposed between these layers. The negative-electrode layer contains a powder of a negative-electrode active material and a powder of a solid electrolyte. In the negative-electrode active material, a charge-discharge volume change ratio is 1% or less and the powder has an average particle size of 8 μm or less. The solid-electrolyte layer is formed by a vapor-phase process.

In this configuration, the negative-electrode layer is formed by molding the powders and the solid-electrolyte layer is formed as a film by a vapor-phase process. As a result, an increase both in the capacity and in the volume power density can be both achieved.

When the charge-discharge volume change ratio of the negative-electrode active material is 1% or less, the expansion and contraction of the negative-electrode layer during charging and discharging can be suppressed and generation of cracks in the solid-electrolyte layer and degradation of the adhesion between the negative-electrode layer and the solid-electrolyte layer can be suppressed. The charge-discharge volume change ratio (%) denotes a value ([Vc−Vd]/Vd) expressed as a percentage, the value being obtained by subtracting a volume (Vd) at the time of Li release in the fully discharged state (the state at the time when the end-of-discharge voltage is reached) from a volume (Vc) at the time of Li insertion in the fully charged state (the state in which the end-of-charge voltage is reached) and by dividing the resultant volume change amount by the volume (Vd) at the time of Li release in the fully discharged state. Accordingly, an internal short circuit is less likely to occur and enhancement of the charge-discharge cycle capability can be achieved.

In the present invention, the negative-electrode layer contains a powder of a negative-electrode active material and a powder of a solid electrolyte. Accordingly, the negative-electrode layer has a structure in which the solid electrolyte is present around the negative-electrode active-material particles. In the case of negative-electrode active materials having different particle sizes, even when these materials have the same volume change ratio, the material that has a larger particle size has a larger volume change absolute amount. Accordingly, when the powder of the negative-electrode active material has an average particle size of 8 μm or less, the negative-electrode active-material particles have a small volume change absolute amount. Thus, the expansion and contraction of the negative-electrode layer during charging and discharging can be effectively suppressed and generation of cracks in the solid-electrolyte layer and degradation of the adhesion between the negative-electrode layer and the solid-electrolyte layer can be suppressed. In addition, when the powder of the negative-electrode active material has an average particle size of 8 μm or less, the molded negative-electrode layer has a low surface roughness and hence formation (film-formation) of the solid-electrolyte layer or the like is easily achieved on the negative-electrode layer by a vapor-phase process. The powder of the negative-electrode active material preferably has an average particle size of, for example, 1 μm or less so that the volume change amount of the particles becomes small and the surface roughness of the negative-electrode layer becomes low.

As described above, the negative-electrode active material undergoes changes in volume (expansion and contraction) during charging and discharging and hence, strictly, changes in the average particle size of the powder during charging and discharging also occur. However, in the present invention, since the negative-electrode active material has a volume change ratio of 1% or less, the average particle size of the powder substantially does not change. The average particle size of the powder of the negative-electrode active material contained in the negative-electrode layer is substantially the same as the average particle size of the raw material powder to be molded. The particle size is determined in the state in which the negative-electrode active material has released Li (that is, in the discharged state). Herein, the average particle size denotes the average particle size defined in Japanese Industrial Standard (JIS) Z 8901:2006 (the arithmetic mean of the diameters of particles photographed by an optical-microscope process or a transmission-electron-microscope process).

The negative-electrode layer preferably has a thickness of, for example, 30 μm or more, more preferably 60 μm or more, in view of ensuring the capacity. In the present invention, since the negative-electrode layer is formed by molding powders, the negative-electrode layer having such a large thickness is easily formed, compared with the case of film formation by a vapor-phase process. On the other hand, the solid-electrolyte layer preferably has a thickness of, for example, 30 μm or less, more preferably 10 μm or less, in view of ensuring the volume power density. In the present invention, since the solid-electrolyte layer is formed as a film by a vapor-phase process, the solid-electrolyte layer having such a small thickness is easily formed, compared with the case of molding powder. In addition, the solid-electrolyte layer formed as a film by a vapor-phase process is dense, compared with the case of molding powder; accordingly, internal short circuits due to Li dendrite growth are less likely to occur.

Examples of the vapor-phase process include physical vapor deposition (PVD) processes such as a vacuum deposition process, a pulsed laser deposition (PLD) process, a laser ablation process, an ion-plating process, and a sputtering process. The conditions of the vapor-phase process are not particularly limited. However, the lower the impurity concentration in the atmosphere in the film-formation chamber during film formation, the denser the resultant film becomes. Accordingly, the degree of vacuum in the film-formation chamber is preferably set to be 0.002 Pa or less prior to the initiation of the film formation.

In addition, in the present invention, giving and receiving of Li ions are performed at the interface between the negative-electrode layer and the solid-electrolyte layer. Here, when the negative-electrode layer is formed of a negative-electrode active-material powder alone, giving and receiving of the ions are smoothly performed at the negative-electrode-layer interface. However, the following problem may occur: the ions do not sufficiently diffuse in the internal portion of the negative-electrode layer (the portion being separated from the interface) and the negative-electrode active-material powder in the internal portion of the negative-electrode layer is not effectively used for the battery reaction. This problem tends to occur more severely as the thickness of the negative-electrode layer increases (for example, 20 μm or more). For this reason, the negative-electrode layer contains a powder of a negative-electrode active material and a powder of a solid electrolyte; the negative-electrode active-material powder and the solid-electrolyte powder are mixed in the negative-electrode layer. Thus, the solid-electrolyte powder promotes diffusion of the ions in the internal portion of the negative-electrode layer so that the negative-electrode active-material powder in the internal portion of the negative-electrode layer can be effectively used for the battery reaction. As a result, the internal resistance can be decreased.

(2) In a nonaqueous electrolyte battery according to an embodiment of the present invention, the negative-electrode active material is Li₄Ti₅O₁₂ or non-graphitizable carbon (hard carbon).

Li₄Ti₅O₁₂ or hard carbon (non-graphitizable carbon) is preferred because the charge-discharge volume change ratio is 1% or less. In such a negative-electrode active material, Li is inserted through entry of Li ions into the interstitial sites of crystal lattices during charging; and Li is released through detachment of Li ions from the interstitial sites of crystal lattices during discharging. Accordingly, the charge-discharge volume change ratio is low, compared with, for example, Li metal, Li alloys, and metals that alloy with Li. In addition, the charge-discharge volume change ratio is also low, compared with graphite, which has been commonly used. Incidentally, graphite has a charge-discharge volume change ratio of about 10%. When Li metal or a Li alloy is used as the negative-electrode active material, Li is deposited on the surface of the negative-electrode layer and tends to grow in a dendritic form.

(3) In a nonaqueous electrolyte battery according to an embodiment of the present invention, the solid electrolyte contained in the negative-electrode layer is a sulfide-based solid electrolyte.

Typically, solid electrolytes are sulfide-based solid electrolytes containing Li₂S and oxide-based solid electrolytes such as Li₃PO₄ and LiPON. Such a sulfide-based solid electrolyte is, for example, a Li₂S—P₂S₅-based electrolyte, a Li₂S—SiS₂-based electrolyte, or a Li₂S—B₂S₃-based electrolyte, and may further contain P₂O₅ or Li₃PO₄. Sulfide-based solid electrolytes are preferred because they generally have a higher lithium-ion conductivity than oxide-based solid electrolytes. In particular, among sulfide-based solid electrolytes, more preferred are Li₂S—P₂S₅-based solid electrolytes, which have a high lithium-ion conductivity.

The negative-electrode layer, which contains a powder of a negative-electrode active material and a powder of a solid electrolyte, may optionally further contain a conductive aid or a binder. Here, when the solid electrolyte contained in the negative-electrode layer is a sulfide-based solid electrolyte, the sulfide-based solid electrolyte is softer than oxide-based solid electrolytes and has high deformability and hence tends to exhibit the function of a binder. Examples of the conductive aid include carbon blacks such as acetylene black (AB) and Ketjenblack (KB). Examples of the binder include polytetrafluoroethylene (PTFE) and poly(vinylidene fluoride) (PVdF).

(4) In a nonaqueous electrolyte battery according to an embodiment of the present invention, the content of the powder of the negative-electrode active material in the negative-electrode layer is 30 mass % or more and 80 mass % or less.

When the content of the negative-electrode active-material powder in the negative-electrode layer is less than 30 mass %, the proportion of the negative-electrode active material with respect to the entirety of the negative-electrode layer is low and the capacity may become low. On the other hand, when the content of the negative-electrode active-material powder in the negative-electrode layer is more than 80 mass %, the proportion of the solid-electrolyte powder and the like correspondingly becomes low. Thus, the internal resistance may become high or the binding property may be degraded. Regarding the proportions of the negative-electrode active-material powder and the solid-electrolyte powder in the negative-electrode layer, for example, the proportion of the negative-electrode active-material powder may be 30 to 80 mass % and the proportion of the solid-electrolyte powder may be 20 to 70 mass %. Regarding the content of the negative-electrode active-material powder in the negative-electrode layer, the lower limit is more preferably more than 30 mass %, still more preferably 40 mass % or more; and the upper limit is more preferably less than 80 mass %, still more preferably 70 mass % or less.

(5) In a nonaqueous electrolyte battery according to an embodiment of the present invention, the solid-electrolyte layer contains a sulfide-based solid electrolyte.

As described above, sulfide-based solid electrolytes are preferred because they generally have a higher lithium-ion conductivity than oxide-based solid electrolytes. In particular, more preferred are Li₂S—P₂S₅-based solid electrolytes, which have a high lithium-ion conductivity.

The positive-electrode layer contains a positive-electrode active material. Examples of the positive-electrode active material include lithium-containing composite oxides such as LiCoO₂, LiNiO₂, LiMn₂O₄, LiFePO₄, LiNi_{1/3}Co_{1/3}Mn_{1/3}O₂, and LiNi_{0.8}Co_{0.5}Al_{0.05}O₂. In particular, among these positive-electrode active materials, preferred are LiNi_{1/3}Co_{1/3}Mn_{1/3}O₂ and LiNi_{0.8}Co_{0.15}Al_{0.05}O₂, which have a charge-discharge volume change ratio of 1% or less. Incidentally, LiCoO₂, which has been commonly used, has a charge-discharge volume change ratio of 2.6%. When the positive-electrode layer is formed by pressing powder as with the negative-electrode layer, a powder of a positive-electrode active material having an average particle size of 6 μm or less is preferably used.

In a nonaqueous electrolyte battery according to an embodiment of the present invention, an interface layer that decreases the interface resistance between the positive-electrode layer and the solid-electrolyte layer may be disposed between these layers. For example, when an oxide is used as the positive-electrode active material and a sulfide is used as the solid electrolyte, a reaction between the oxide and the sulfide may occur, resulting in an increase in the interface resistance of the interface between the positive-electrode layer and the solid-electrolyte layer. For this reason, the interface layer may be provided that suppresses, in a near-interface region between the positive-electrode layer and the solid-electrolyte layer, interdiffusion between these layers to suppress the reaction. As a result, the interface resistance can be decreased. Examples of a material for forming the interface layer include LiNbO₃, LiTaO₃, Li₄Ti₅O₁₂, LiₓLa_{(2-X)/3}TiO₃ (X=0.1 to 0.5), Li_{7+X}La₃Zr₂O_{12+(X/2)} (−5≦X≦3), Li_{3.6}Si_{0.6}P_{0.4}O₄, Li_{1.3}Al_{0.3}Ti_{1.7}(PO₄)₃, Li_{1.8}Cr_{0.8}Ti_{1.2}(PO₄)₃, and Li_{1.4}In_{0.4}Ti_{1.6}(PO₄)₃. These materials may be used alone or in combination of two or more thereof.

The negative-electrode layer is a molded body obtained by mixing a powder of a negative-electrode active material, a powder of a solid electrolyte, and optionally a conductive aid or a binder, and by pressing the powder mixture. In this pressing, the pressure applied is preferably 100 MPa to 600 MPa. After the press-molding, a heat treatment may be performed. In this case, the heating temperature is preferably 120° C. to 250° C.

The positive-electrode layer and the above-described interface layer may be formed by a vapor-phase process as with the solid-electrolyte layer. Alternatively, the positive-electrode layer may be formed as a molded body obtained by pressing a powder of a positive-electrode active material as with the negative-electrode layer; or the positive-electrode layer may be formed by, for example, a wet process (coating process) such as a sol-gel process, a colloid process, or a casting process. When the positive-electrode layer is formed as a molded body of a positive-electrode active-material powder, as with the negative-electrode layer, the powder is preferably mixed with a solid-electrolyte powder, and a conductive aid or a binder may be optionally added. In such a case, regarding the proportions of the positive-electrode active-material powder and the solid-electrolyte powder in the positive-electrode layer, for example, the proportion of the positive-electrode active-material powder may be 50 to 90 mass % and the proportion of the solid-electrolyte powder may be 10 to 50 mass %. The solid-electrolyte powder is preferably a sulfide-based solid-electrolyte powder.

### Advantageous Effects of Invention

In a nonaqueous electrolyte battery according to the present invention, the negative-electrode layer is formed by molding powders; the solid-electrolyte layer is formed as a film by a vapor-phase process; and the negative-electrode active material has a charge-discharge volume change ratio of 1% or less. As a result, the battery can have a high capacity, a high volume power density, and an enhanced charge-discharge cycle capability.

### DESCRIPTION OF EMBODIMENTS

### EXAMPLE 1

Nonaqueous electrolyte batteries (lithium-based batteries) according to the present invention were produced and the battery performance thereof was evaluated.

### [Production of Batteries]

A powder of Li₄Ti₅O₁₂ (average particle size: 1 μm) and a powder of a Li₂S—P₂S₅-based solid electrolyte (average particle size: 1 to 5 μm) were mixed in a mass ratio of 50:50 to prepare a negative-electrode mixture. Subsequently, a steel use stainless (SUS) 316L foil (thickness: 10 μm) that was to serve as a negative-electrode collector was placed in a mold and the negative-electrode mixture was charged onto the foil. The foil and the negative-electrode mixture were then press-molded at a pressure of 360 MPa. Thus, a negative-electrode member was produced in which a negative-electrode layer (molded body of Li₄Ti₅O₁₂ and Li₂S—P₂S₅-based solid electrolyte) was formed on the negative-electrode collector. In this negative-electrode member, the negative-electrode layer had a thickness of 60 μm. The Li₂S—P₂S₅-based solid electrolyte was prepared by subjecting Li₂S and P₂S₅ in a molar ratio of 4:1 to ball-milling mixing and then to a heat treatment in an Ar atmosphere at 240° C. for an hour.

A powder of LiCoO₂ (average particle size: 10 μm) and a powder of a Li₂S—P₂S₅-based solid electrolyte (average particle size: 1 to 5 μm) were mixed in a mass ratio of 70:30 to prepare a positive-electrode mixture. Subsequently, a SUS 316L foil (thickness: 20 μm) that was to serve as a positive-electrode collector was placed in a mold and the positive-electrode mixture was charged onto the foil. The foil and the positive-electrode mixture were then press-molded at a pressure of 360 MPa. Thus, a positive-electrode member was produced in which a positive-electrode layer (molded body of LiCoO₂ and Li₂S—P₂S₅-based solid electrolyte) was formed on the positive-electrode collector. In this positive-electrode member, the positive-electrode layer had a thickness of 70 μm. The Li₂S—P₂S₅-based solid electrolyte was prepared by subjecting Li₂S and P₂S₅ in a molar ratio of 4:1 to ball-milling mixing and then to a heat treatment in an Ar atmosphere at 240° C. for an hour.

Subsequently, on the negative-electrode layer of the negative-electrode member and on the positive-electrode layer of the positive-electrode member, films of a Li₂S—P₂S₅-based solid electrolyte were formed by a PLD process to thereby form solid-electrolyte layers (thickness: 5 μm). The films of a Li₂S—P₂S₅-based solid electrolyte were formed of a mixture of Li₂S and P₂S₅ in a molar ratio of 4:1.

The positive-electrode member and the negative-electrode member were arranged such that the members were in contact with each other and the solid-electrolyte layers of the members faced each other. These members were held for 130 minutes under the application of a pressure of 16 MPa in the arrangement direction and under heating at 190° C. As a result, the solid-electrolyte layers were fused together to bond the members together. Thus, the battery was produced.

The thus-produced nonaqueous electrolyte battery was contained in a charge-discharge-test cell. This sample was defined as No. 1-1.

A battery was produced as with Sample No. 1-1 except that the Li₄Ti₅O₁₂ powder was replaced by a graphite powder (average particle size: 5 μm) in the production of the negative-electrode member. This battery was contained in a charge-discharge-test cell. This sample was defined as No. 1-2.

A battery was produced as with Sample No. 1-1 except that the LiCoO₂ powder was replaced by a LiNi_{0.8}Co_{0.15}Al_{0.05}O₂ powder (average particle size: 6 μm) in the production of the positive-electrode member. This battery was contained in a charge-discharge-test cell. This sample was defined as No. 1-3.

### [Evaluations of Batteries]

The configurations of the produced batteries are described in Table I. The produced batteries were subjected to evaluations below. The results are described in Table II.

### <Charge-Discharge Cycle Capability (Capacity Retention Ratio)>

A charge-discharge cycle test in which a single charge-discharge was defined as a single cycle was performed to examine the charge-discharge cycle capability (capacity retention ratio). The charge-discharge cycle test was performed under the following conditions: at room temperature (about 25° C.); when the negative-electrode active material was Li₄Ti₅O₁₂, the cutoff voltage (end-of-discharge voltage to end-of-charge voltage) was 1.0 V to 3.5 V; when the negative-electrode active material was graphite, the cutoff voltage was 3.0 V to 4.2 V; and, in both of these cases, the current was constant at a current density (id) of 50 μA/cm². The capacity retention ratio was obtained by dividing a discharge capacity at the 50th cycle by the initial discharge capacity at the 1st cycle. The initial discharge capacity and the capacity retention ratio of each battery are described in Table II.

### <Negative-Electrode Availability Ratio>

The availability ratio of the negative electrode in the case of a current density of 50 μA/cm² was determined from the initial discharge capacity in the above-described charge-discharge cycle test. In addition, under the above-described test conditions, the availability ratio of the negative electrode in the case of a current density of 300 μA/cm² was determined from an initial discharge capacity in the case of a constant current having a current density of 300 μA/cm². Note that the availability ratio was obtained by dividing the discharge capacity by the theoretical capacity of the negative electrode. The theoretical capacity of the negative electrode was the product of the theoretical capacity per unit volume of the negative-electrode active material and the volume of the negative-electrode active material contained in the negative electrode layer. The negative-electrode availability ratios of each battery at current densities (id=50 μA/cm² and 300 μA/cm²) are described in Table II.

### <Rate Ratio>

A rate ratio was determined from the initial discharge capacity in the case of a constant current having a current density of 50 μA/cm² and the initial discharge capacity in the case of a constant current having a current density of 300 μA/cm². Note that the rate ratio was obtained by dividing the discharge capacity in the case of a current density of 300 μA/cm² by the discharge capacity in the case of a current density of 50 μA/cm². The rate ratios of the batteries are described in Table II.

### <Internal Resistance>

In the 1st cycle of the above-described charge-discharge cycle test, discharging at a 50 μA/cm² constant current was initiated in the fully charged state achieved by charging to the end-of-charge voltage. After a predetermined time elapsed from the initiation of discharging, the discharge voltage was measured and the internal resistance was determined. Note that the internal resistance was obtained by subtracting this discharge voltage from the end-of-charge voltage, dividing the resultant voltage by 2, and dividing the resultant value by 50 μA/cm². The internal resistances of the batteries are described in Table II.

TABLE I

| | Negative-electrode layer | | | | | | | | |
|---|---|---|---|---|---|---|---|---|---|
| | Negative- | | | | Positive-electrode layer | | | | |
| | electrode | Particle | | | | Particle | | | Cutoff |
| Sample | active | size | Content | Thickness | Positive-electrode | size | Content | Thickness | voltage |
| No. | material | (μm) | (mass %) | (μm) | active material | (μm) | (mass %) | (μm) | (V) |
| 1-1 | Li₄Ti₅O₁₂ | 1 | 50 | 60 | LiCoO₂ | 10 | 70 | 70 | 1.0 to 3.5 |
| 1-2 | Graphite | 5 | 50 | 60 | LiCoO₂ | 10 | 70 | 70 | 3.0 to 4.2 |
| 1-3 | Li₄Ti₅O₁₂ | 1 | 50 | 60 | LiNi_{0.8}Co_{0.15}Al_{0.05}O₂ | 6 | 70 | 70 | 1.0 to 3.5 |

TABLE II

| | | Availability ratio | Availability ratio | Rate | | |
|---|---|---|---|---|---|---|
| Sample | Discharge capacity | (%) | (%) | ratio | Internal resistance | Capacity retention |
| No. | (mAh/cm²) | (id = 50 μA/cm²) | (id = 300 μA/cm²) | (%) | (Ωcm²) | ratio (%) |
| 1-1 | 2.32 | 93 | 85 | 92 | 70 | 95 |
| 1-2 | 2.21 | 88 | 81 | 92 | 40 | — |
| 1-3 | 2.45 | 98 | 91 | 93 | 70 | 97 |

As a result, it was demonstrated that the batteries of Sample Nos. 1-1 and 1-3 operated with stability for 50 or more cycles without the occurrence of an internal short circuit. In addition, the discharge capacity retention ratio at the 50th cycle with respect to the initial discharge capacity at the 1st cycle was 95% for the battery of Sample No. 1-1 and 97% for the battery of Sample No. 1-3. In particular, the battery of Sample No. 1-3 had a high discharge capacity retention ratio of 96% or more at the 50th cycle and was found to be excellent in terms of the charge-discharge cycle capability. Furthermore, in the batteries of Sample Nos. 1-1 and 1-3, the initial discharge capacity was 2 mAh/cm² or more; the negative-electrode availability ratios at current densities of 50 μA/cm² and 300 μA/cm² were 80% or more; the rate ratio was 80% or more; and the internal resistance was less than 100 Ωcm². In contrast, in the battery of Sample No. 1-2, a phenomenon in which charging to 4.2 V was not achieved was observed at the 24th cycle; an internal short circuit probably occurred.

### EXAMPLE 2

Batteries in which the average particle size of a powder of a negative-electrode active material was varied were produced and the battery performance thereof was evaluated.

Batteries were produced as with Sample No. 1-3 except that the average particle size of the Li₄Ti₅O₁₂ powder was changed to 8 μm and 20 μm in the production of the negative-electrode members. These batteries were contained in charge-discharge-test cells. These samples were defined as Nos. 2-1 and 2-2.

The configurations of the produced batteries are described in Table III. The produced batteries were subjected to evaluations as in EXAMPLE 1. The results are described in Table IV.

TABLE III

| | Negative-electrode layer | | | | | | | | |
|---|---|---|---|---|---|---|---|---|---|
| | Negative- | | | | Positive-electrode layer | | | | |
| | electrode | Particle | | | | Particle | | | Cutoff |
| Sample | active | size | Content | Thickness | Positive-electrode | size | Content | Thickness | voltage |
| No. | material | (μm) | (mass %) | (μm) | active material | (μm) | (mass %) | (μm) | (V) |
| 2-1 | Li₄Ti₅O₁₂ | 8 | 50 | 60 | LiNi_{0.8}Co_{0.15}Al_{0.05}O₂ | 6 | 70 | 70 | 1.0 to 3.5 |
| 2-2 | Li₄Ti₅O₁₂ | 20 | 50 | 60 | LiNi_{0.8}Co_{0.15}Al_{0.05}O₂ | 6 | 70 | 70 | 1.0 to 3.5 |

TABLE IV

| | | Availability ratio | Availability ratio | Rate | | |
|---|---|---|---|---|---|---|
| Sample | Discharge capacity | (%) | (%) | ratio | Internal resistance | Capacity retention |
| No. | (mAh/cm²) | (id = 50 μA/cm²) | (id = 300 μA/cm²) | (%) | (Ωcm²) | ratio (%) |
| 2-1 | 2.41 | 96 | 86 | 89 | 80 | 97 |
| 2-2 | 2.12 | 85 | 65 | 77 | 120 | 95 |

As a result, compared with the battery of Sample No. 2-2 in which the negative-electrode active-material powder was coarse (average particle size: 20 μm), the battery of Sample No. 2-1 in which the powder was fine (average particle size: 8 μm) had a discharge capacity retention ratio of 96% or more at the 50th cycle and was found to be excellent in terms of the charge-discharge cycle capability. Furthermore, in the battery of Sample No. 2-1, the initial discharge capacity was 2 mAh/cm² or more; the negative-electrode availability ratios at current densities of 50 μA/cm² and 300 μA/cm² were 80% or more; the rate ratio was 80% or more; and the internal resistance was less than 100 Ωcm². Thus, it was found that the capacity was high, the rate characteristic was good, and the internal resistance was low. In contrast to this battery of Sample No. 2-1, in the battery of Sample No. 2-2, the negative-electrode availability ratio at the high current (current density of 300 μA/cm²) was found to be a small value of less than 80% and the rate characteristic was found to be degraded. In addition, the battery of Sample No. 2-2 was found to have a high internal resistance of 100 Ωcm² or more.

### EXAMPLE 3

Batteries in which the content of a powder of a negative-electrode active material in a negative-electrode layer was varied in the range of 30 to 80 mass % were produced and the battery performance thereof was evaluated.

Batteries were produced as with Sample No. 1-3 except that the content of the Li₄Ti₅O₁₂ powder was changed to 30 mass %, 40 mass %, 70 mass %, and 80 mass % in the production of the negative-electrode members. Note that the negative-electrode layers had the following thicknesses to provide the same theoretical capacity with respect to the entirety of each negative-electrode layer: 280 μm in the case of 30 mass %; 200 μm in the case of 40 mass %, 100 μm in the case of 70 mass %, and 80 μm in the case of 80 mass %. These batteries were contained in charge-discharge-test cells. These samples were defined as Nos. 3-1, 3-2, 3-3, and 3-4.

The configurations of the produced batteries are described in Table V. The produced batteries were subjected to evaluations as in EXAMPLE 1. The results are described in Table VI.

TABLE V

| | Negative-electrode layer | | | | | | | | |
|---|---|---|---|---|---|---|---|---|---|
| | Negative- | | | | Positive-electrode layer | | | | |
| | electrode | Particle | | | | Particle | | | Cutoff |
| Sample | active | size | Content | Thickness | Positive-electrode | size | Content | Thickness | voltage |
| No. | material | (μm) | (mass %) | (μm) | active material | (μm) | (mass %) | (μm) | (V) |
| 3-1 | Li₄Ti₅O₁₂ | 1 | 30 | 280 | LiNi_{0.8}Co_{0.15}Al_{0.05}O₂ | 6 | 70 | 70 | 1.0 to 3.5 |
| 3-2 | Li₄Ti₅O₁₂ | 1 | 40 | 200 | LiNi_{0.8}Co_{0.15}Al_{0.05}O₂ | 6 | 70 | 70 | 1.0 to 3.5 |
| 3-3 | Li₄Ti₅O₁₂ | 1 | 70 | 100 | LiNi_{0.8}Co_{0.15}Al_{0.05}O₂ | 6 | 70 | 70 | 1.0 to 3.5 |
| 3-4 | Li₄Ti₅O₁₂ | 1 | 80 | 80 | LiNi_{0.8}Co_{0.15}Al_{0.05}O₂ | 6 | 70 | 70 | 1.0 to 3.5 |

TABLE VI

| | | Availability ratio | Availability ratio | Rate | | |
|---|---|---|---|---|---|---|
| Sample | Discharge capacity | (%) | (%) | ratio | Internal resistance | Capacity retention |
| No. | (mAh/cm²) | (id = 50 μA/cm²) | (id = 300 μA/cm²) | (%) | (Ωcm²) | ratio (%) |
| 3-1 | 2.10 | 84 | 83 | 99 | 110 | 97 |
| 3-2 | 2.18 | 87 | 84 | 96 | 90 | 97 |
| 3-3 | 2.38 | 95 | 81 | 85 | 90 | 96 |
| 3-4 | 1.74 | 70 | 49 | 70 | 150 | 96 |

As a result, the batteries of Sample Nos. 3-1 to 3-4 each had a discharge capacity retention ratio of 96% or more at the 50th cycle and were found to be excellent in terms of the charge-discharge cycle capability. In particular, in the batteries of Sample Nos. 3-2 and 3-3 in which the contents of the negative-electrode active material were 40 mass % and 70 mass %, the initial discharge capacity was 2 mAh/cm² or more; the negative-electrode availability ratios at current densities of 50 μA/cm² and 300 μA/cm² were 80% or more; the rate ratio was 80% or more; and the internal resistance was less than 100 Ωcm². Thus, it was found that the capacity was high, the rate characteristic was good, and the internal resistance was low. In contrast, in the batteries of Sample Nos. 3-1 and 3-4 in which the contents of the negative-electrode active material were 30 mass % and 80 mass %, the internal resistance was a large value of 100 Ωcm² or more. In particular, in the battery of Sample No. 3-4, the initial discharge capacity was less than 2 mAh/cm²; the negative-electrode availability ratios at current densities of 50 μA/cm² and 300 μA/cm² were small values of less than 80%; and the capacity and the rate characteristic were found to be degraded.

### EXAMPLE 4

Batteries in which the raw material of a negative-electrode active material was varied were produced and the battery performance thereof was evaluated.

A battery was produced as with Sample No. 1-3 except that the Li₄Ti₅O₁₂ powder was replaced by a hard-carbon powder (average particle size: 5 μm) in the production of the negative-electrode member. Note that the negative-electrode layer had a thickness of 80 μm. This battery was contained in a charge-discharge-test cell. This sample was defined as No. 4-1.

A battery was produced as with Sample No. 4-1 except that the hard-carbon powder was replaced by a graphite powder (average particle size: 5 μm) in the production of the negative-electrode member. This battery was contained in a charge-discharge-test cell. This sample was defined as No. 4-2.

The configurations of the produced batteries are described in Table VII. The produced batteries were subjected to evaluations as in EXAMPLE 1. The results are described in Table VIII. Note that, in the case where the negative-electrode active material was hard carbon, the cutoff voltage was set to be 3.0 V to 4.2 V as in the case of graphite.

TABLE VII

| | Negative-electrode layer | | | | | | | | |
|---|---|---|---|---|---|---|---|---|---|
| | Negative- | | | | Positive-electrode layer | | | | |
| | electrode | Particle | | | | Particle | | | Cutoff |
| Sample | active | size | Content | Thickness | Positive-electrode | size | Content | Thickness | voltage |
| No. | material | (μm) | (mass %) | (μm) | active material | (μm) | (mass %) | (μm) | (V) |
| 4-1 | Hard | 5 | 50 | 80 | LiNi_{0.8}Co_{0.15}Al_{0.05}O₂ | 6 | 70 | 70 | 3.0 to 4.2 |
| | carbon | | | | | | | | |
| 4-2 | Graphite | 5 | 50 | 80 | LiNi_{0.8}Co_{0.15}Al_{0.05}O₂ | 6 | 70 | 70 | 3.0 to 4.2 |

TABLE VIII

| | | Availability ratio | Availability ratio | Rate | | |
|---|---|---|---|---|---|---|
| Sample | Discharge capacity | (%) | (%) | ratio | Internal resistance | Capacity retention |
| No. | (mAh/cm²) | (id = 50 μA/cm²) | (id = 300 μA/cm²) | (%) | (Ωcm²) | ratio (%) |
| 4-1 | 2.31 | 92 | 87 | 94 | 50 | 96 |
| 4-2 | 2.45 | 98 | 81 | 83 | 40 | — |

As a result, it was demonstrated that the battery of Sample No. 4-1 in which the negative-electrode active material was hard carbon operated with stability for 50 or more cycles without the occurrence of an internal short circuit. In addition, the battery had a high discharge capacity retention ratio of 96% or more at the 50th cycle and was found to be excellent in terms of the charge-discharge cycle capability. Furthermore, in the battery of Sample No. 4-1, the initial discharge capacity was 2 mAh/cm² or more; the negative-electrode availability ratios at current densities of 50 μA/cm² and 300 μA/cm² were 80% or more; the rate ratio was 80% or more; and the internal resistance was less than 100 Ωcm². Thus, it was found that the capacity was high, the rate characteristic was good, and the internal resistance was low. In contrast, in the battery of Sample No. 4-2 in which the negative-electrode active material was graphite, as with the battery of Sample No. 1-2, the phenomenon in which charging to 4.2 V was not achieved was observed before the 50th cycle was reached; an internal short circuit probably occurred.

From the above-described results, the following has been demonstrated. For the negative-electrode layer, by using a negative-electrode active material that has a low charge-discharge volume change ratio and is constituted by fine particles (for example, Li₄Ti₅O₁₂ or hard carbon (non-graphitizable carbon)), expansion and contraction of the negative-electrode layer during charging and discharging can be suppressed and the charge-discharge cycle capability can be enhanced.

In addition, the following has been demonstrated. For the positive-electrode layer, by using a positive-electrode active material that has a low charge-discharge volume change ratio (volume change ratio of 1% or less) and is constituted by fine particles (average particle size of 6 μm or less) (for example, LiNi_{0.8}Co_{0.15}Al_{0.05}O₂), expansion and contraction of the positive-electrode layer during charging and discharging can be suppressed and the charge-discharge cycle capability can be further enhanced.

The present invention is not limited to the above-described embodiments. Modifications can be properly made without departing from the spirit and scope of the present invention.

### INDUSTRIAL APPLICABILITY

A nonaqueous electrolyte battery according to the present invention can be used for, for example, a power supply of a cellular phone, a notebook computer, a digital camera, or an electric vehicle.

1. A nonaqueous electrolyte battery comprising a positive-electrode layer, a negative-electrode layer, and a solid-electrolyte layer disposed between these layers,
wherein the negative-electrode layer contains a powder of a negative-electrode active material and a powder of a solid electrolyte,
in the negative-electrode active material, a charge-discharge volume change ratio is 1% or less and the powder has an average particle size of 8 μm or less, and
the solid-electrolyte layer is formed by a vapor-phase process.

2. The nonaqueous electrolyte battery according to claim 1, wherein the negative-electrode active material is Li₄Ti₅O₁₂ or non-graphitizable carbon.

3. The nonaqueous electrolyte battery according to claim 1, wherein the solid electrolyte contained in the negative-electrode layer is a sulfide-based solid electrolyte.

4. The nonaqueous electrolyte battery according to claim 1, wherein a content of the powder of the negative-electrode active material in the negative-electrode layer is 30 mass % or more and 80 mass % or less.

5. The nonaqueous electrolyte battery according to claim 1, wherein the solid-electrolyte layer contains a sulfide-based solid electrolyte.
